(19) United States
(12) Patent Application Publication
(10) Pub. No.: US 2026/0233227 A1
(43) Pub. Date: Aug. 13, 2026

(54) MICROFLUIDIC CONCENTRATION CONTROL SYSTEM, AND METHOD FOR OPERATING SAME

(71) Applicant: PROVALABS, INC., Seoul (KR)

(72) Inventors: Sung Jae KIM, Seoul (KR); Taewan KIM, Gyeonggi-do (KR); Sungjae HA, Gyeonggi-do (KR)

(21) Appl. No.: 19/106,617

(22) PCT Filed: Jul. 24, 2023
(86) PCT No.: PCT/KR2023/010626

§ 371 Date: Feb. 25, 2025

(30) Foreign Application Priority Data
Aug. 26, 2022 (KR) 10-2022-0107965

(51) Int. Cl. B01L 3/00

(52) U.S. Cl. CPC B01L 3/502761; B01L 2200/14; B01L 2200/16; B01L 2300/0645; B01L 2300/0681; B01L 2300/0861

(57) ABSTRACT

A microfluidic concentration control system according to an embodiment of the present disclosure may include a sample concentration unit including a microchannel into which a sample solution containing a sample is injected so as to form an ion depletion zone by an Ion Concentration Polarization (ICP) phenomenon, an ion-selective permeable membrane connected to the microchannel, and an electrode capable of applying a voltage to each end of the microchannel; an observation unit configured to observe a concentration state of the sample injected into the microchannel; and a control unit configured to control the sample concentration unit so that a position of the concentration plug formed in the microchannel is adjusted based on information observed by the observation unit.

### TECHNICAL FIELD

Embodiments of the present invention relate to a microfluidic concentration control system and a method of operating the same.

### BACKGROUND ART

Since the concentration of samples to be detected in the bio-environment field, such as medical, pharmaceutical, drug testing, water quality testing, and clinical diagnosis, is extremely low, the technology of concentrating samples to increase detection and analysis efficiency is being studied very importantly.

In order to detect target materials such as biomaterials, biodiesel, and heavy metals in the sample, an expensive detector may be used, or an operation of amplifying the concentration of the target material in the sample preparation step may be preceded.

In the case of cell-level materials where various methods of concentration exist, there is a need for a method of non-destructively concentrating a target material. However, in the case of enrichment methods targeting small target materials such as cells, there is a problem that the detection sensitivity is low, and only skilled researchers can use it smoothly, resulting in poor accessibility.

Therefore, there is a need to develop a new type of concentration control system for target materials of fine scale.

### PRIOR ART DOCUMENTS

### Patent Document

(Patent Document 1) Prior Document 1: U.S. Patent Application Publication No. US2011/0198225 (published on Aug. 18, 2011)

(Patent Document 2) Prior Document 2: Jung Hoon Lee et al., Korean Society of Machinery, Volume 57, No. 10, pp. 43 to 47 (issued on Oct. 1, 2017).

### DISCLOSURE

### Technical Problem

An embodiment of the present invention provides a new microfluidic concentration control system using Ion Concentration Polarization (ICP) phenomenon and an operating method thereof.

### Technical Solution

A microfluidic concentration control system according to an embodiment of the present invention may include a sample concentration unit including a microchannel into which a sample solution containing a sample is injected, an ion-selective permeable membrane connected to the microchannel, and an electrode capable of applying a voltage to each end of the microchannel so as to form an ion depletion zone by an Ion Concentration Polarization (ICP) phenomenon; an observation unit configured to observe a concentration state of the sample injected into the microchannel; and a control unit configured to control the sample concentration unit so that a position of the concentration plug formed in the microchannel is adjusted based on information observed by the observation unit.

An operating method of a microfluidic concentration control system according to an embodiment of the present invention may include: forming an ion depletion zone by an Ion Concentration Polarization (ICP) phenomenon by applying a voltage to both ends of a microchannel through which a sample solution containing a sample flows (step 1); obtaining an image of a concentration state of the sample solution (step 2); calculating a center position of a concentration plug in the microchannel based on the image (step 3); and adjusting the center position of the concentration plug based on a predetermined target position (step 4).

### Advantageous Effects

According to the present invention, a new microfluidic concentration control system which is relatively easy to control by utilizing the Ion Concentration Polarization (ICP) phenomenon and an operating method thereof are provided.

### DESCRIPTION OF DRAWINGS

FIG. 1 is a diagram illustrating a microfluidic concentration control system according to an embodiment of the present invention.

FIG. 2 is a diagram illustrating a sample concentration unit of FIG. 1 in more detail.

FIG. 3 is a diagram illustrating generation and movement of an ion depletion region and a concentration plug in the microfluidic concentration control system according to an embodiment of the present invention.

FIG. 4 is an image illustrating the movement of the concentration plug in FIG. 3 in more detail.

FIG. 5 is a flowchart illustrating an operating method of the microfluidic concentration control system according to an embodiment of the present invention.

FIG. 6 is a flowchart illustrating step S400 of FIG. 5 in more detail.

FIG. 7 is a graph illustrating an operating result of the microfluidic concentration control system according to an embodiment of the present invention.

### BEST MODES OF THE INVENTION

A microfluidic concentration control system according to an embodiment of the present invention may include a sample concentration unit including a microchannel into which a sample solution containing a sample is injected, an ion-selective permeable membrane connected to the microchannel, and an electrode capable of applying a voltage to each end of the microchannel so as to form an ion depletion zone by an Ion Concentration Polarization (ICP) phenomenon; an observation unit configured to observe a concentration state of the sample injected into the microchannel; and a control unit configured to control the sample concentration unit so that a position of the concentration plug formed in the microchannel is adjusted based on information observed by the observation unit.

In an embodiment, the sample concentration unit may include one or more microchannels.

In an embodiment, the sample concentration unit may include: a main microchannel into which the sample solution is injected and to which a reference voltage is applied at one end and a control voltage which is changed according to the control of the control unit is applied at the other end; and a buffer microchannel into which a buffer solution is injected and having both ends connected with a ground voltage.

In an embodiment, the observation unit may observe the sample concentration unit in real time.

In an embodiment, the control unit may calculate the position of the concentration plug based on the information observed by the observation unit.

In an embodiment, the control unit may control the sample concentration unit to adjust the position of the concentration plug based on the position of the concentration plug and a predetermined target position.

In an embodiment, the control unit may control a magnitude of one or more of a voltage and a current applied to the sample concentration unit.

An operating method of a microfluidic concentration control system according to an embodiment of the present invention may include: forming an ion depletion zone by an Ion Concentration Polarization (ICP) phenomenon by applying a voltage to both ends of a microchannel through which a sample solution containing a sample flows (step 1); obtaining an image of a concentration state of the sample solution (step 2); calculating a center position of a concentration plug in the microchannel based on the image (step 3); and adjusting the center position of the concentration plug based on a predetermined target position (step 4).

In an embodiment, the step 4 may include: calculating an error between the center position of the concentration plug calculated in the step 3 and the target position; determining a control value to be applied to the microchannel based on the error; and applying the determined control value to the microchannel.

In an embodiment, the steps 2 to 4 may be repeatedly performed according to a predetermined period.

### Modes of the Invention

The structural or functional descriptions of the embodiments disclosed in this specification or the application are merely exemplified for the purpose of describing the embodiments according to the technical idea of the present invention, and the embodiments according to technical idea of the invention may be implemented in various forms in addition to the embodiments disclosed in the specification or the application, and the technical idea of this invention is not to be construed as being limited to the embodiments described in this specification or application.

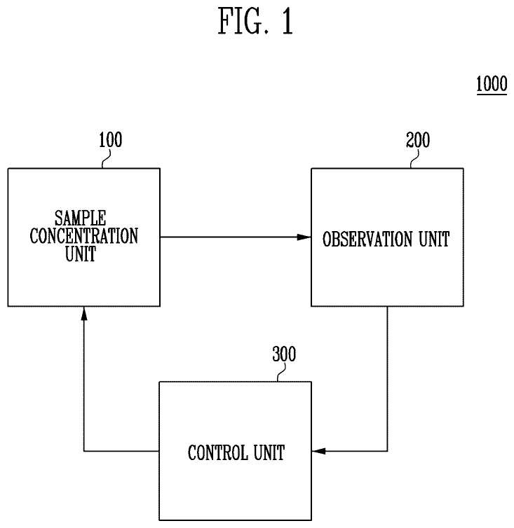

FIG. 1 is a diagram illustrating a microfluidic concentration control system according to an embodiment of the present invention.

Referring to FIG. 1, a microfluidic concentration control system 1000 may include a sample concentration unit 100, an observation unit 200, and a control unit 300.

The sample concentration unit 100 may include one or more microchannels. One or more of the microchannels may be injected with a sample solution containing a sample.

The sample is a material that is subject to concentration and position control by the microfluidic concentration control system 1000, and the diameter of the particles may range from several nm to several tens of μm. For example, the sample may include proteins, fluorescent particles, lipid nanoparticles, microbeads or exosomes, but not limited thereto.

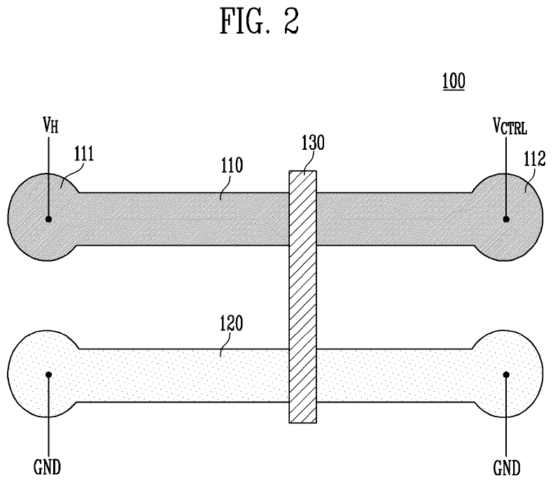

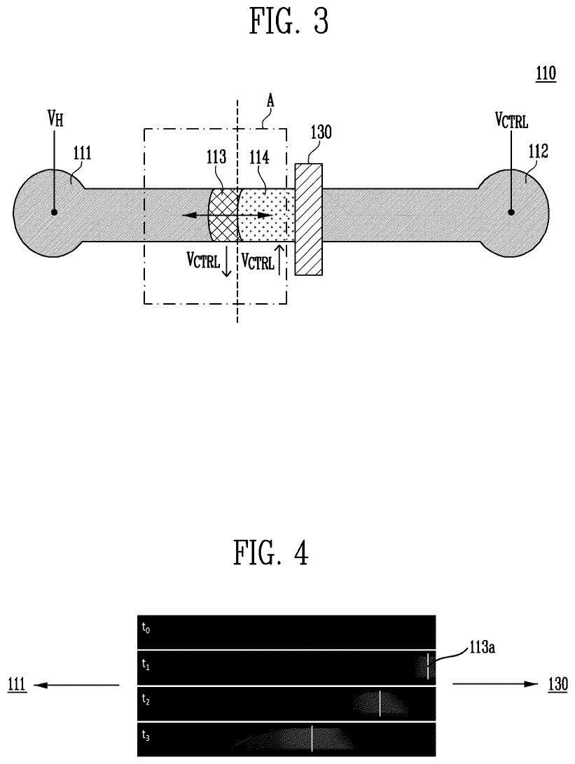

When an electric field is applied to the sample concentration unit 100, an Ion Concentration Polarization (ICP) phenomenon may occur, and accordingly, an ion depletion region may be formed in the microchannel of the sample concentration unit 100. The sample concentration unit 100 will be described in more detail in the following description of FIGS. 2 and 3. The sample concentration unit 100 may include an electrode for applying a voltage to the microchannel.

The observation unit 200 may observe a concentration state of the sample injected into the microchannel of the sample concentration unit 100. In an embodiment, the observation unit 200 may obtain an image of a portion of the microchannel of the sample concentration unit 100. More specifically, the image of the portion of the microchannel where a sample plug is formed may be obtained. In an embodiment, the observation unit 200 may observe the sample concentration unit 100 in real time. In an embodiment, a video of the sample concentration unit 100 may be captured in real time, and an image may be obtained by capturing the video at a predetermined period.

The observation unit 200 may include a light source. In an embodiment, the observation unit 200 may observe a fluorescent material in the sample solution. Accordingly, the light source in the observation unit 200 may provide an excitation wavelength of 340 nm to 800 nm suitable for observing the fluorescent material.

The observation unit 200 may include a filter and a mirror. That is, the observation unit 200 may include an excitation filter and an emission filter suitable for excitation and emission wavelengths in order to facilitate the observation of each fluorescent material, and may also include a dichroic mirror.

In addition, the observation unit 200 may include an objective lens for observing fluorescence. The magnification of the objective lens may be between 2× and 100×.

In addition, the observation unit 200 may include an image sensor capable of converting the received visual data into electrical data. The image sensor may be, for example, a Charge-Coupled Device (CCD) image sensor or a Complementary Metal-Oxide Semiconductor (CMOS) image sensor.

The control unit 300 may control the sample concentration unit 100 based on the information observed by the observation unit 200. In an embodiment, the control unit 300 may calculate a position of the sample concentration plug formed in the microchannel based on the image acquired by the observation unit 200. For example, when the fluorescent sample to be concentrated in the image acquired by the observation unit 200 is concentrated to a concentration higher than a certain level and has a brightness higher than a predetermined threshold, the control unit 300 may recognize the sample as a concentration plug and calculate the position of the concentration plug. In an embodiment, the control unit 300 may calculate the center of gravity of the concentration plug in an area recognized as the concentration plug. In an embodiment, the control unit 300 may obtain the position and brightness value of the pixel from the image obtained by the observation unit 200. The control unit 300 may calculate the position and brightness information of the concentration plug from the position and brightness value of the pixel.

The control unit 300 may adjust the position of the concentration plug in the microchannel of the sample concentration unit 100 based on the position of the concentration plug and a predetermined target position. In an embodiment, the control unit 300 may determine a control value to be applied to the microchannel based on the position of the concentration plug and the predetermined target position, and may adjust the position of the concentration plug in the microchannel by applying the determined control value to the microchannel. In one embodiment, the control value may be one or more of the magnitude of the voltage and the magnitude of the current applied to the microchannel.

In an embodiment, the control unit 300 may adjust the position of the concentration plug through feedback control. For example, various feedback control methods such as Proportional-Integral-Differential control (PID) or Adaptive Control may be used.

In an embodiment, the control unit 300 may include a processor that calculates the position of the current concentration plug and determines the control value to be applied to the microchannel. In addition, the control unit 300 may include a variable power supply device that provides a control value such as a voltage or a current to the sample concentration unit 100.

FIG. 2 is a diagram illustrating the sample concentration unit of FIG. 1 in more detail.

Referring to FIG. 2, the sample concentration unit 100 may include a main microchannel 110, a buffer microchannel 120, and an ion-selective permeable membrane 130.

The sample solution may be injected into the main microchannel 110. The main microchannel 110 may include an inlet for injecting the sample solution at one end. The main microchannel 110 may include an outlet at the other end through which the sample solution flows out. In an embodiment, the main microchannel 110 may have a shape that extends long in one direction so that the sample solution has a structure that is easy to move along a path.

A reference voltage V_{H} may be applied to one end 111 of the main microchannel 110. The reference voltage V_{H} may be a fixed voltage or a variable voltage. A control voltage V_{CTRL} that changes according to the control of the control unit may be applied to the other end 112 of the main microchannel 110. The sample concentration unit 100 may include electrodes capable of applying voltages to both ends 111 and 112 of the main microchannel 110.

A buffer solution may be injected into the buffer microchannel 120. In an embodiment, the buffer solution may be an aqueous electrolyte solution having a concentration corresponding to the material injected into the main microchannel 110. The buffer microchannel 120 may have a shape that extends long in one direction or may be in the form of a “ [symbol] ”, but is not limited thereto.

Both ends of the buffer microchannel 120 may be connected to a ground voltage. The sample concentration unit 100 may include electrodes capable of connecting the both ends of the buffer microchannel 120 with the ground voltage. The buffer microchannel 120 may be used to increase the efficiency of ion exchange through an ion-selective permeable membrane.

In an embodiment, the width of the microchannels 110, 120 may be between 10 μm and 1000 μm, and the height of the microchannels 110, 120 may range from 1 μm to 1000 μm. The microchannels 110, 120 may include a flexible polymeric material or a hard plastic. For example, flexible polymers such as PDMS or hard plastics such as acrylic, polycarbonate, or the like, may be used as the material of the microchannel. The microchannels 110, 120 may have a straight or curved shape.

The ion-selective permeable membrane 130 may be connected to each of the main microchannel 110 and the buffer microchannel 120 by one or more contact points. The ion-selective permeable membrane 130 may cause Ion Concentration polarization (ICP) phenomenon. The ion-selective permeable membrane 130 may be a cation permeable membrane or an anion permeable membrane. In an embodiment, the ion-selective permeable membrane 130 may be Nafion.

FIG. 3 is a diagram illustrating generation and movement of the ion depletion region and the concentration plug in the microfluidic concentration control system according to an embodiment of the present invention.

When electric fields V_{H}, V_{CTRL} are applied to the one end 111 and the other end 112 of the main microchannel 110, the Ion Concentration Polarization (ICP) phenomenon occurs in an area adjacent to the ion-selective permeable membrane 130 in the main microchannel 110, thereby forming an ion depletion region 114. Ion concentration polarization is one of the electrochemical transfer phenomena observed around structures with nanomembranes. It is theoretically known that when the thickness of the electric double layer is similar to the size of the nanomembrane, the electric double layer overlaps inside the nanomembrane, showing single ion permeability. Ions with the same charge as the wall charge may not pass through the nanomembrane due to diffusion and drift forces, and only ions with the opposite charge to the wall charge pass through, resulting in depletion and excess of ions at the nanomembrane interface.

The ion depletion region 114 may be used as a concentration mechanism for the sample material by taking advantage of the fact that the sample material having the same polarity as the nanomembrane may not pass through the ion depletion region 114. The sample material may be concentrated starting from the boundary of the ion depletion region 114 to form a concentration plug 113. The concentration equilibrium point of the sample material may be determined by advection, which is transferred according to the flow, and electro-migration, which occurs due to the electrophoretic mechanism, and the concentration form of the sample material may appear differently depending on the dominance of advection or electrical transfer.

More specifically, the concentration form may be determined by comparing the absolute value of the electrophoretic mobility of the sample material with the critical mobility. When the absolute value of the electrophoretic mobility of the sample material is less than the critical mobility, the advection mechanism may prevail, and when the absolute value of electrophoretic mobility is greater than the critical mobility, the electro-migration mechanism may prevail. The sample material with the absolute value of electrophoretic mobility that is less than the critical mobility may be stacked on a specific point so that the area of the concentration plug gradually increases, and the sample material with the large absolute value of electrophoretic mobility may propagate in one end direction (inlet or outlet direction) while changing the concentration equilibrium point, that is, the position of the concentration plug.

The size of the ion depletion region 114 may vary depending on the type of ion-selective permeable membrane 130, the potential difference between the both ends 111, 112 of the main microchannel 110, and the concentration distribution state of ions. In an embodiment, when the potential difference between the both ends 111, 112 of the main microchannel 110 increases under a specific initial condition, that is, when the control voltage V_{CTRL} decreases, the area of the ion depletion region 114 increases, and accordingly, the concentration plug 113 at the boundary of the ion depletion area 114 is pushed in the direction of the one end 111 of the main microchannel 110. Otherwise, when the potential difference decreases, that is, the control voltage V_{CTRL} increases, the size of the ion depletion region 114 decreases, and the concentration plug moves in the direction of the ion-selective permeable membrane 130.

The size and position of the concentration plug 113 due to the ion concentration polarization phenomenon may vary depending on the potential difference, the amount of current, the flow rate, the concentration time, the shape of the channel, and the type and concentration of the electrolyte. The microfluidic concentration control system according to an embodiment of the present invention may fix the concentration plug 113 to a predetermined position by adjusting factors that may determine the size and position of the concentration plug 113 in real time.

FIG. 4 is an image illustrating the movement of the concentration plug in FIG. 3 in more detail.

FIG. 4 is an image illustrating part A of FIG. 3 in which the absolute value of the electrophoretic mobility of the sample material is greater than the threshold.

Referring to FIGS. 3 and 4, when the voltage is applied to the main microchannel 110, a center position 113a of the concentration plug moves toward the one end 111 of the main microchannel over time (t₀ to t₃) even though control values such as the magnitude of the applied voltage or the magnitude of the current are fixed. In other words, in order to fix the position of the concentration plug to a specific position, the control value for the microchannel may have to be changed appropriately in consideration of the movement of the concentration plug.

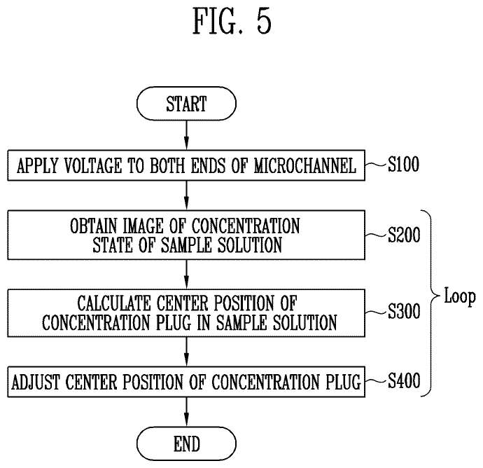

FIG. 5 is a flowchart illustrating an operating method of the microfluidic concentration control system according to an embodiment of the present invention.

Referring to FIG. 5, in step S100, a voltage may be applied to both ends of the microchannel through which the sample solution containing the sample flows. The applied voltage may be a voltage for implementing the Ion Concentration Polarization (ICP) phenomenon. In addition, the applied initial voltage may be determined in consideration of values such as the type of sample solution, the type of ion-selective permeable membrane, the predetermined target position, the flow rate in the microchannel of the sample solution, or the like. The microchannel may be connected to the ion-selective permeable membrane at one or more contact points, thereby forming the ion depletion zone due to Ion Concentration Polarization (ICP) in the microchannel.

An image of the concentration state of the sample solution may be obtained in step S200. In an embodiment, the observation unit may observe around the ion depletion region where the concentration plug may be generated by using an optical device, and may obtain an image around the ion depletion region according to a predetermined period. For example, the observation unit may obtain a video of a portion in which the sample is concentrated in the microchannel by using an optical device such as a microscope, and may capture an image from the video in real time to obtain the image of the portion in which the sample is concentrated.

In step S300, the center position of the concentration plug formed in the microchannel may be calculated based on the image obtained in step S200. In an embodiment, the control unit may identify the concentration plug from the image acquired by the observation unit. For example, the control unit may recognize a pixel having a brightness greater than or equal to a predetermined threshold value or having a specific color as the concentrated plug. To this end, a brightness value greater than the brightness of the background may be set as a threshold value for recognizing the concentration plug. Alternatively, a specific wavelength range may be set to a color range identified by the concentration plug. Accordingly, pixels having a brightness greater than the threshold value or pixels having a color in the specific wavelength range may thus be separated from the background and recognized as the concentration plug. In this case, various image processing techniques may be additionally applied to reduce noise and increase sensitivity. The control unit may calculate the center position of the concentration plug from the region recognized as the concentration plug, that is, the pixels recognized as the concentration plug. The control unit may calculate the center of gravity by reflecting the degree of concentration of each area in the concentration plug, thereby calculating the center position of the concentration plug. In an embodiment, the center of gravity of the concentration plug may be calculated by weighting the brightness of each of the pixels recognized as the concentration plug. Alternatively, the center of gravity of the concentration plug may be calculated by taking into account the color representing the pixels recognized as the concentration plug. Accordingly, the control unit may obtain the center position of the concentration plug and the accumulated concentration amount.

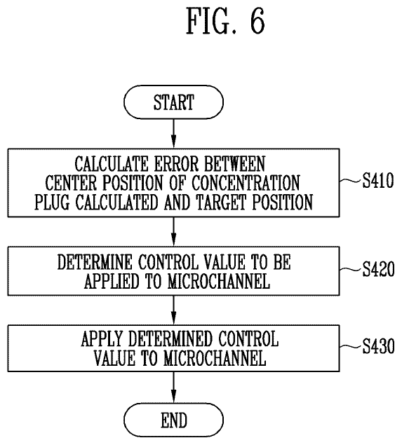

In step S400, the control unit may adjust the center position of the concentration plug in the microchannel based on the predetermined target position. In an embodiment, the center position of the concentration plug may be adjusted based on a difference between the predetermined target position and the center position of a current concentration plug calculated in step S300. In an embodiment, the control unit may adjust the center position of the concentration plug through various feedback control methods. The control unit may turn on/off the application of the feedback control according to the user's instruction or its own judgment. The control unit may adjust the center position of the concentration plug by changing the control values applied to the microchannel. In an embodiment, the control value changed to adjust the center position of the concentration plug may be the magnitude of the voltage or the magnitude of the current applied to the microchannel. In the following description of FIG. 6, step S400 will be described in more detail. In addition, the target position may be changed after the concentration plug according to the user's instruction is created.

In an embodiment, steps S200 to S400 may be repeatedly performed according to a predetermined period. Accordingly, the position of the concentration plug may be fixed to the predetermined target position. The position of the concentration plug is fixed to the target position may refer to that the center position of the concentration plug exists at a position within a certain error range from the target position.

FIG. 6 is a flowchart illustrating step S400 of FIG. 5 in more detail.

Referring to FIG. 6, in step S410, the control unit may calculate an error between the center position of the concentration plug calculated in step S300 of FIG. 5 and the predetermined target position. The target position may be predetermined as the target position of the concentration plug, and the target position may be changed after the concentration plug is formed.

In step S420, the control unit may determine the control value to be applied to the microchannel based on the error calculated in step S410. For example, the calculated error may determine the magnitude of the voltage or the magnitude of the current to be applied to the microchannel in order to move the center position of the concentration plug to the predetermined target position. Various feedback control methods may be applied to determine the control value. For example, Proportional-Integral-Differential Control (PID) or Adaptive Control may be applied, and setting values for such feedback control may be set in advance.

In step S430, the control unit may apply the determined control value to the microchannel. Then, steps S200 and S300 of FIG. 5 may be performed again to calculate the center position of the concentration plug, and steps S410 to S430 may be performed again therefrom.

The microfluidic concentration control system and the method of operating the microfluidic concentration control system according to the embodiments of the present disclosure may implement separation and concentration using ion concentration polarization for the microfluid containing the sample. The position of the concentration plug may be actively controlled by introducing the observation unit that observes the concentration pattern of the sample in real time and the control unit that adjusts the electrical driving conditions of the sample concentration unit in real time. More specifically, the position of the concentration plug of the sample material generated by the ion concentration polarization phenomenon may be fixed by feedback control or moved to another position, so that large-volume separation and concentration may be performed for a long time or the concentration plug may be moved to any outlet to extract the concentrated sample effectively without user intervention. Therefore, users who are not skilled professionals may easily operate the concentration control system, and ion concentration polarization-based diagnosis, water quality testing, protein concentration devices, or the like, may easily be commercialized. Furthermore, the concentration plug may easily be moved to the position where the obtaining channel is formed, so that it may also be applied as a system for recovering the concentrated sample material.

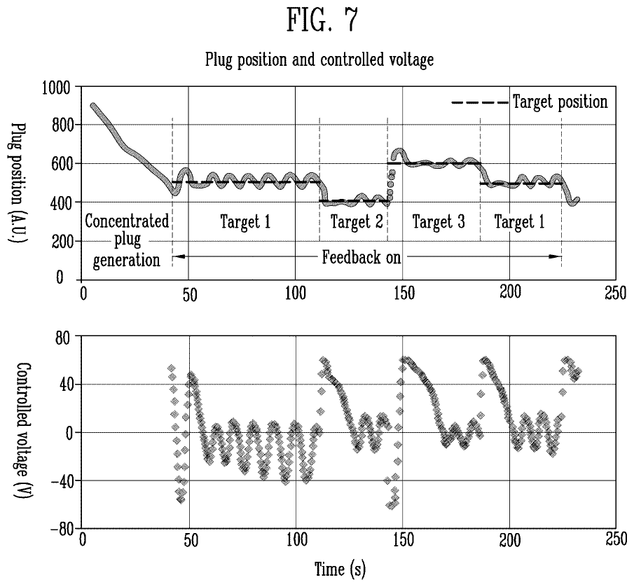

FIG. 7 is a graph illustrating an operating result of the microfluidic concentration control system according to an embodiment of the present invention.

Referring to FIG. 7, an experiment was conducted to prove the position control of the concentration plug. A sample concentration unit containing microchannels with a channel width of 150 μm and a height of 15 μm was prepared. As sample solution containing Alexa Fluor 430, which is a fluorescent material, as the sample material and 2.5 mM potassium chloride (KCl) as the electrolyte was injected into the main microchannel. Nafion, a cation permeable membrane, was used as the ion-selective permeable membrane of the device, and the buffer microchannel was supplemented with 2.5 mM aqueous potassium chloride solution.

As an initial condition, an initial concentration plug was formed by applying 60 V at the reference voltage V_{H} to the one end of the main microchannel. After the concentration plug is formed, when the concentration plug is concentrated to show the brightness greater than or equal to the predetermined threshold brightness, the control unit including the feedback control software may recognize the plug, and thus the feedback control is started.

When the feedback control is started, the control value of the V_{CTRL} is transmitted to the other end of the main microchannel to which the floating electrode is connected. At this time, the PID control method was adopted to determine the control value, and the P gain for PID control was set to 0.004, the I gain to 0, and the D gain to 0.04.

The target position where the concentration plug was to be fixed was initially set to 500 px, and after stabilizing at 500 px, the target position is sequentially changed to 400 px, 600 px, and 500 px.

The results can be confirmed through FIG. 7. After the initial plug was created, the target positions were sequentially set as 500 px (Target 1), 400 px (Target 2), 600 px (Target 3), and 500 px (Target 1) and it can be confirmed that the location of the concentrated plug converges within the error range for the target location within a short period of time from the time when the target location was set.

More specifically, it took an average of 4 seconds for the difference in the position of the concentrated plug with respect to the target position to converge to within 5% of the full screen scale, and the size of the ripple converged to an error range of 1.6% compared to the full screen.

### DESCRIPTION OF SYMBOLS

100: SAMPLE CONCENTRATION UNIT
110: MAIN MICROCHANNEL
120: BUFFER MICROCHANNEL
130: ION-SELECTIVE PERMEABLE MEMBRANE
200: OBSERVATION UNIT
300: CONTROL UNIT

1. A microfluidic concentration control system comprising:
a sample concentration unit including a microchannel into which a sample solution containing a sample is injected, an ion-selective permeable membrane connected to the microchannel, a first electrode and a second electrode capable of applying a voltage to both ends of the microchannel so as to form an ion depletion zone by an Ion Concentration Polarization (ICP) phenomenon, wherein a predetermined reference value is applied to the first electrode and a first control value is applied to the second electrode;
an observation unit configured to observe a concentration state of the sample injected into the microchannel; and
a control unit configured to calculate a current position of a concentration plug formed in the microchannel based on information observed by the observation unit, and determine a second control value to be applied to the second electrode based on the current position of the concentration plug and a predetermined target position,
wherein the observation unit repeatedly observes the concentration state of the sample according to a predetermined period, and
wherein the control unit repeatedly calculates the current position of the concentration plug according to the predetermined period and repeatedly determines the second control value to be applied to the second electrode based thereon.

2. The microfluidic concentration control system according to claim 1, wherein the sample concentration unit includes one or more microchannels.

3. The microfluidic concentration control system according to claim 2,
wherein the sample concentration unit includes:
a main microchannel into which the sample solution is injected and including the first electrode and the second electrode at both ends; and
a buffer microchannel into which a buffer solution is injected and having both ends connected with a ground voltage.

4. The microfluidic concentration control system according to claim 1, wherein the observation unit observes the sample concentration unit in real time.

5. The microfluidic concentration control system according to claim 1, wherein, when the second control value is determined, the determined second control value is applied to the second electrode.

6. The microfluidic concentration control system according to claim 1, wherein the reference value is a constant control value or a time-varying control value.

7. The microfluidic concentration control system according to claim 1, wherein the reference value is one or more of a voltage and a current applied to the first electrode, and
wherein the first control value and the second control value are one or more of a voltage and a current applied to the second electrode.

8. A method of operating a microfluidic concentration control system, the method comprising:
forming an ion depletion zone by an Ion Concentration Polarization (ICP) phenomenon by applying a predetermined reference value to a first electrode located at one end of a microchannel through which a sample solution containing a sample flows and applying a first control value to a second electrode located at an other end of the microchannel (step 1);
obtaining an image of a concentration state of the sample solution (step 2);
calculating a center position of a concentration plug in the microchannel based on the image (step 3); and
adjusting the center position of the concentration plug by determining a second control value to be applied to the second electrode based on a predetermined target position and the center position of the concentration plug (step 4),
wherein the steps 2 to 4 are repeatedly performed according to a predetermined cycle.

9. The method of claim 8, wherein the step 4 includes:
calculating an error between the center position of the concentration plug calculated in the step 3 and the target position;
determining the second control value to be applied to the second electrode based on the error; and
applying the determined second control value to the second electrode.

10. The method of claim 8, wherein the reference value is one or more of a voltage and a current applied to the first electrode, and
wherein the first control value and the second control value are one or more of a voltage and a current applied to the second electrode.
